(19) United States
(12) Patent Application Publication
(10) Pub. No.: US 2012/0218240 A1
(43) Pub. Date: Aug. 30, 2012

(54) PLASMA DISPLAY PANEL DRIVING METHOD AND PLASMA DISPLAY DEVICE

(76) Inventor: Yutaka Yoshihama, Osaka (JP)

(21) Appl. No.: 13/505,696

(22) PCT Filed: Oct. 29, 2010
(86) PCT No.: PCT/JP2010/006392

§ 371 Date: May 2, 2012

(30) Foreign Application Priority Data
Nov. 2, 2009 (JP) 2009-251692

(51) Int. Cl. G06F 3/038

(52) U.S. Cl. 345/208

(57) ABSTRACT

Stable address discharge is caused while securing a sufficient voltage setting margin, and an image of high quality is displayed on a plasma display panel. For this purpose, in the selective initializing operation, first discharge is caused by applying first voltage to the sustain electrode and applying up-ramp waveform voltage to the scan electrode. Next, second discharge is caused by applying down-ramp waveform voltage to the scan electrode. Next, third discharge is caused by applying positive rectangular waveform voltage to the scan electrode. Next, fourth discharge is caused by applying second voltage higher than the first voltage to the sustain electrodes and applying down-ramp waveform voltage to the scan electrode. The length of applying time of the positive rectangular waveform voltage to the scan electrode is changed based on the number of sustain pulses occurring in the sustain period of the immediately preceding subfield.

### TECHNICAL FIELD

The present invention relates to a driving method for a plasma display panel of an alternating-current surface discharge type, and a plasma display apparatus.

### BACKGROUND ART

An alternating-current surface discharge type panel typical as a plasma display panel (hereinafter referred to as “panel”) has many discharge cells between a front substrate and a rear substrate that are faced to each other. The front substrate has a plurality of display electrode pairs each of which is formed of a pair of scan electrode and sustain electrode. The rear substrate has a plurality of data electrodes. Ultraviolet rays are generated by gas discharge in the discharge cells, and respective phosphors of red, green, and blue are exited to emit light with the ultraviolet rays, thereby providing color display.

A subfield method is generally used as a method of driving the panel. In this method, one field period is divided into a plurality of subfields, and the subfields in which light is emitted are combined, thereby performing gradation display. Each subfield includes an initializing period, an address period, and a sustain period.

In the initializing period, an initializing operation of causing initializing discharge and producing wall charge required for the subsequent address operation is performed. The initializing operation includes a forced initializing operation of causing initializing discharge regardless of the operation in the immediately preceding subfield, and a selective initializing operation of causing initializing discharge only in the discharge cell that has undergone address discharge in the immediately preceding subfield.

In the address period, address discharge is selectively caused in a discharge cell according to an image to be displayed to produce wall charge.

In the sustain period, sustain pulses are alternately applied to scan electrodes and sustain electrodes to cause sustain discharge, and light is emitted in a phosphor layer in the corresponding discharge cell, thereby displaying an image. The light emission in the phosphor layer by the sustain discharge is related to the gradation display, and the light emission following the forced initializing operation is not related to the gradation display.

As one of subfield methods, a driving method has been studied in which the luminance (hereinafter referred to as “luminance of black level”) in displaying black as the lowest gradation is reduced, the light emission that is not related to the gradation display is reduced as much as possible, and the contrast is improved. For example, Patent Literature 1 discloses a driving method in which the number of forced initializing operations is set at one per field and the selective initializing operation is performed in the other subfields. The forced initializing operation is performed using a gently varying ramp waveform voltage.

Patent Literature 2 discloses a driving method in which up-ramp waveform voltage is applied to a scan electrode at the end of the sustain period, and the selective initializing operation is performed by applying down-ramp waveform voltage to the scan electrode in the subsequent initializing period.

As discussed in Patent Literature 2, when ramp waveform voltage is used as a driving voltage waveform, waveform distortion such as wringing can be suppressed. Therefore, the driving voltage waveform can be accurately applied to each electrode in each discharge cell, and stable address discharge can be caused.

However, the discharge caused by the ramp waveform voltage is feeble, and the voltage range that can be applied to each electrode to perform the selective initializing is restricted, so that it is difficult to cause discharge much enough to completely eliminate the history of the wall charge of the discharge cell until then. Therefore, disadvantageously, the driving condition of a discharge cell having undergone the address discharge in the immediately preceding subfield is different from that of a discharge cell having undergone no address discharge, and hence the voltage setting margin of the driving voltage waveform becomes narrow.

### CITATION LIST

### Patent Literature

PTL 1

Unexamined Japanese Patent Publication No. 2000-242224

PTL 2

Unexamined Japanese Patent Publication No. 2008-256774

### SUMMARY OF THE INVENTION

The present invention provides a driving method for a panel, in which, one field is formed of a plurality of subfields having an initializing period, an address period, and a sustain period, and a panel that has a plurality of discharge cells having a scan electrode, a sustain electrode, and a data electrode is driven. In the initializing period in a subfield, one of the forced initializing operation and the selective initializing operation is performed. In the forced initializing operation, initializing discharge is caused in a discharge cell regardless of the operation in the immediately preceding subfield. In the selective initializing operation, initializing discharge is selectively caused only in the discharge cell that has undergone address discharge in the address period of the immediately preceding subfield. In the selective initializing operation, first discharge where the sustain electrode is used as a negative electrode and the scan electrode is used as a positive electrode is caused by applying first voltage to the sustain electrode and applying up-ramp waveform voltage to the scan electrode. Then, second discharge where the scan electrode is used as a negative electrode and the data electrode is used as a positive electrode is caused by applying down-ramp waveform voltage to the scan electrode. Then, third discharge where the sustain electrode is used as a negative electrode and the scan electrode is used as a positive electrode is caused by applying a positive rectangular waveform voltage to the scan electrode. Then, fourth discharge where the scan electrode is used as a negative electrode and the data electrode is used as a positive electrode is caused by applying second voltage higher than the first voltage to the sustain electrode and applying down-ramp waveform voltage to the scan electrode.

The length of the applying time of the positive rectangular waveform voltage to the scan electrode is changed based on the number of sustain pulses occurring in the sustain period of the immediately preceding subfield.

This method can achieve a plasma display apparatus that can generatestable address discharge while securing a sufficient voltage setting margin and can display an image of high display quality.

A plasma display apparatus of the present invention has the following elements:
a panel that has a plurality of discharge cells including a scan electrode, a sustain electrode, and a data electrode; and
a driver circuit that forms one field using a plurality of subfields having an initializing period, an address period, and a sustain period, and drives the panel.
   In the initializing period of a subfield, the driver circuit performs one of the following operations:
the forced initializing operation of generating the initializing discharge in a discharge cell regardless of the operation in the immediately preceding subfield; and
the selective initializing operation of selectively generating the initializing discharge only in the discharge cell that has undergone address discharge in the address period of the immediately preceding subfield.
   In the selective initializing operation, first discharge where the sustain electrode is used as a negative electrode and the scan electrode is used as a positive electrode is caused by applying first voltage to the sustain electrode and applying up-ramp waveform voltage to the scan electrode. Then, second discharge where the scan electrode is used as a negative electrode and the data electrode is used as a positive electrode is caused by applying down-ramp waveform voltage to the scan electrode. Then, third discharge where the sustain electrode is used as a negative electrode and the scan electrode is used as a positive electrode is caused by applying a positive rectangular waveform voltage to the scan electrode. Then, fourth discharge where the scan electrode is used as a negative electrode and the data electrode is used as a positive electrode is caused by applying second voltage higher than the first voltage to the sustain electrode and applying down-ramp waveform voltage to the scan electrode. The length of the applying time of the positive rectangular waveform voltage to the scan electrode is changed based on the number of sustain pulses occurring in the sustain period of the immediately preceding subfield.

This method can achieve a plasma display apparatus that can cause stable address discharge while securing a sufficient voltage setting margin and can display an image of high display quality.

### BRIEF DESCRIPTION OF DRAWINGS

FIG. 1 is an exploded perspective view of a panel used in a plasma display apparatus in accordance with an exemplary embodiment of the present invention.

FIG. 2 is an electrode array diagram of the panel used in the plasma display apparatus in accordance with the exemplary embodiment of the present invention.

FIG. 3 is a waveform chart of driving voltage to be applied to each electrode of the plasma display apparatus in accordance with the exemplary embodiment of the present invention.

FIG. 4A is a diagram showing the relationship between the length of the applying period of the rectangular waveform voltage to a scan electrode in a selective initializing period and voltage Va required for causing stable address discharge in accordance with the exemplary embodiment of the present invention.

FIG. 4B is a diagram showing the relationship between the number of sustain pulses occurring in a sustain period and voltage Va required for causing stable address discharge.

FIG. 4C is a diagram showing one example of time Te set for each subfield in accordance with the exemplary embodiment of the present invention.

FIG. 5 is a circuit block diagram of the plasma display apparatus in accordance with the exemplary embodiment of the present invention.

FIG. 6 is a circuit diagram of a scan electrode driver circuit of the plasma display apparatus in accordance with the exemplary embodiment of the present invention.

FIG. 7 is a circuit diagram of a sustain electrode driver circuit of the plasma display apparatus in accordance with the exemplary embodiment of the present invention.

### DESCRIPTION OF EMBODIMENTS

A plasma display apparatus in accordance with an exemplary embodiment of the present invention will be described hereinafter with reference to the accompanying drawings.

### Exemplary Embodiment

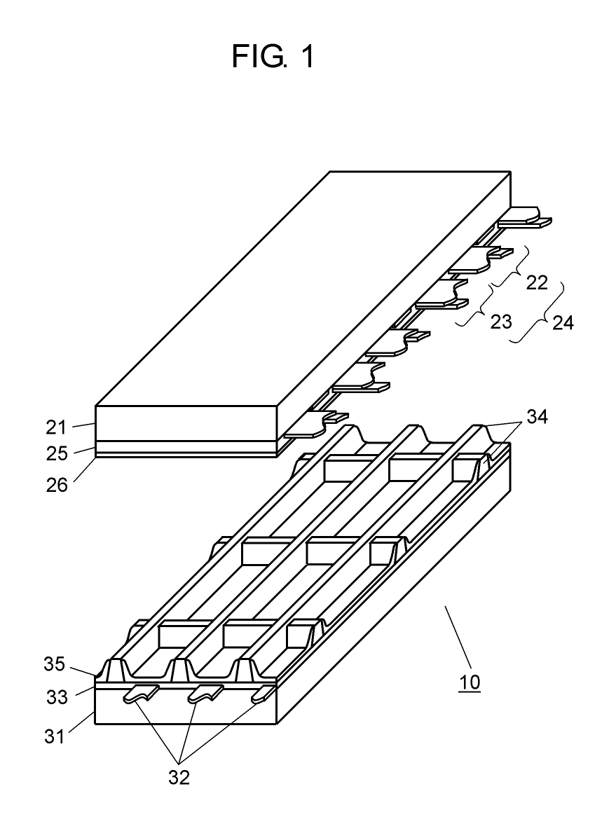

FIG. 1 is an exploded perspective view of panel 10 used in a plasma display apparatus in accordance with an exemplary embodiment of the present invention. A plurality of display electrode pairs 24 formed of scan electrodes 22 and sustain electrodes 23 is disposed on glass-made front substrate 21. Dielectric layer 25 is formed so as to cover display electrode pairs 24, and protective layer 26 is formed on dielectric layer 25. Protective layer 26 is made of magnesium oxide, which is a material of high electron emission performance, in order to facilitate the occurrence of discharge. A plurality of data electrodes 32 is formed on rear substrate 31, dielectric layer 33 is formed so as to cover data electrodes 32, and mesh barrier ribs 34 are formed on dielectric layer 33. Phosphor layers 35 for emitting lights of red, green, and blue are disposed on the side surfaces of barrier ribs 34 and on dielectric layer 33.

Front substrate 21 and rear substrate 31 are faced to each other so that display electrode pairs 24 cross data electrodes 32 with a micro discharge space sandwiched between them, and the outer peripheries of them are sealed by a sealing material such as glass frit. The discharge space is filled with mixed gas of neon and xenon as discharge gas, for example. The discharge space is partitioned into a plurality of sections by barrier ribs 34. Discharge cells are formed in the intersecting parts of display electrode pairs 24 and data electrodes 32. The discharge cells discharge and emit light to display an image.

The structure of panel 10 is not limited to the above-mentioned one, but may be a structure having striped barrier ribs, for example.

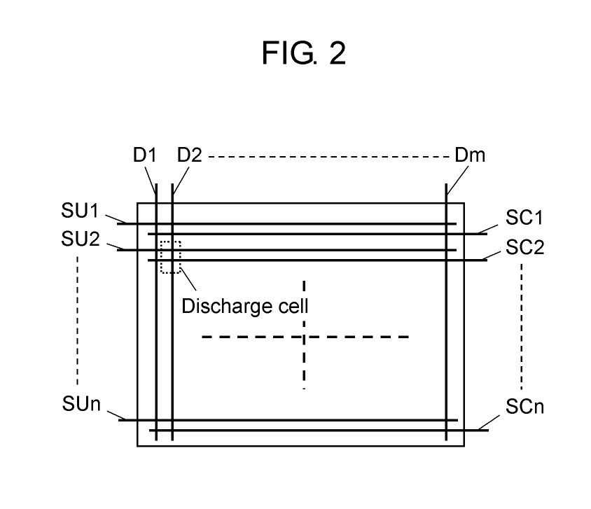

FIG. 2 is an electrode array diagram of panel 10 used in the plasma display apparatus in accordance with the exemplary embodiment of the present invention. Panel 10 has n scan electrode SC1 through scan electrode SCn (scan electrodes 22 in FIG. 1) and n sustain electrode SU1 through sustain electrode SUn (sustain electrodes 23 in FIG. 1) both extended in the row direction, and m data electrode D1 through data electrode Dm (data electrodes 32 in FIG. 1) extended in the column direction. A discharge cell is formed in the part where a pair of scan electrode SCi (i is 1 through n) and sustain electrode SUi intersect with one data electrode Dj (j is 1 through m). Thus, m×n discharge cells are formed in the discharge space.

Next, a driving voltage waveform and operation for driving panel 10 are described. The plasma display apparatus displays an image by a subfield method, in which the plasma display apparatus divides one field (F) into a plurality of subfields, and controls light emission and no light emission of each discharge cell in each subfield (SF).

Each subfield (SF) has an initializing period, an address period, and a sustain period.

In the initializing period, an initializing operation of eliminating the history of the wall charge of the discharge cell until then and producing wall charge required for the subsequent address discharge on each electrode is performed.

In the address period, an address operation of selectively causing address discharge in the discharge cell to emit light and producing wall charge is performed.

In the sustain period, as many sustain pulses as a predetermined number corresponding to a predetermined luminance weight are alternately applied to display electrode pairs 24 in each subfield. Thus, a sustain operation of causing sustain discharge in the discharge cell having undergone the address discharge to cause the discharge cell to emit light is performed. A subfield where the sustain period is omitted may be provided in order to suppress the emission luminance.

In the present exemplary embodiment, for example, one field is formed of 10 subfields (SF1, SF2, . . . , SF10), and respective subfields have luminance weights of (1, 2, 3, 6, 11, 18, 30, 44, 60, 80). A forced initializing operation is performed in the initializing period of subfield SF1, and a selective initializing operation is performed in the initializing periods of subfield SF2 through subfield SF10. However, the present invention is not limited to the above-mentioned subfield structure such as the number of subfields or the luminance weight.

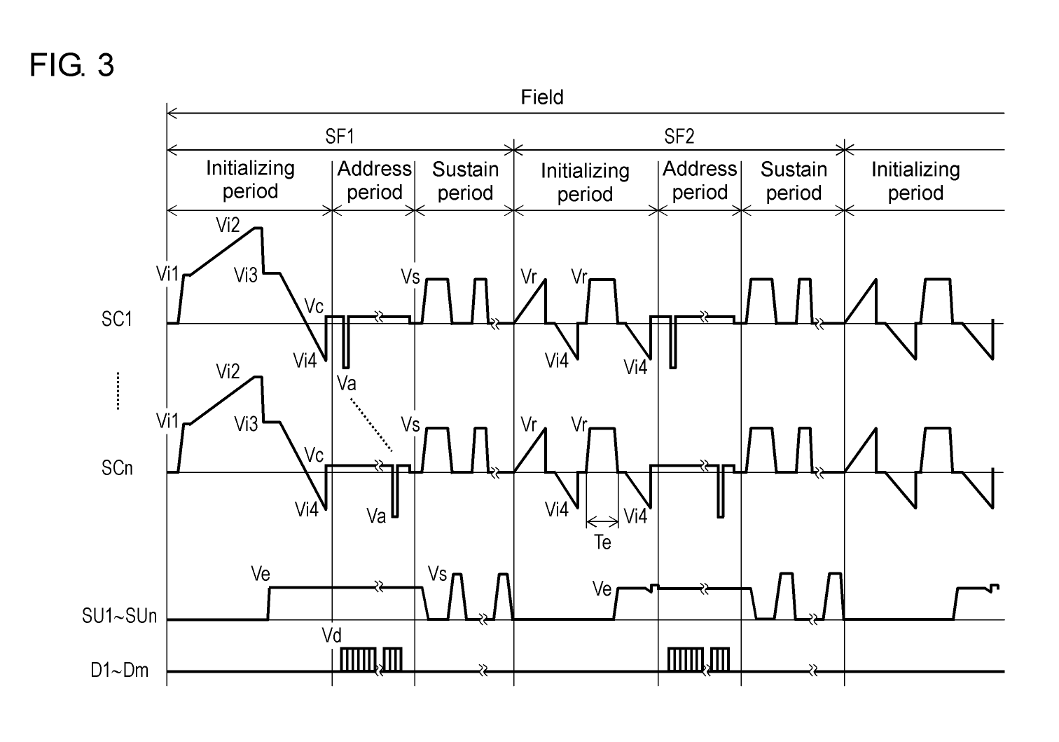

FIG. 3 is a waveform chart of driving voltage to be applied to each electrode of the plasma display apparatus in accordance with the exemplary embodiment of the present invention.

In the first half of the initializing period of subfield SF1 in which the forced initializing operation is performed, voltage 0 (V) is applied to data electrode D1 through data electrode Dm and voltage 0 (V) is applied also to sustain electrode SU1 through sustain electrode SUn. Up-ramp waveform voltage, which gently increases from voltage Vi1 to voltage Vi2, is applied to scan electrode SC1 through scan electrode SCn. Voltage Vi1 is not higher than a discharge start voltage with respect to sustain electrode SU1 through sustain electrode SUn. Voltage Vi2 is higher than the discharge start voltage with respect to sustain electrode SU1 through sustain electrode SUn.

Thus, feeble initializing discharge occurs between scan electrode SC1 through scan electrode SCn and sustain electrode SU1 through sustain electrode SUn, and feeble initializing discharge occurs between scan electrode SC1 through scan electrode SCn and data electrode D1 through data electrode Dm. Negative wall voltage is accumulated on scan electrode SC1 through scan electrode SCn, and positive wall voltage is accumulated on data electrode D1 through data electrode Dm and sustain electrode SU1 through sustain electrode SUn. The wall voltage on the electrodes shows the voltage generated by wall charge accumulated on the dielectric layer for covering the electrodes, the protective layer, and the phosphor layer.

In the latter half of the initializing period, positive voltage Ve is applied to sustain electrode SU1 through sustain electrode SUn, and down-ramp waveform voltage, which gently decreases from voltage Vi3 to voltage Vi4, is applied to scan electrode SC1 through scan electrode SCn. Voltage Vi3 is not higher than the discharge start voltage with respect to sustain electrode SU1 through sustain electrode SUn. Voltage Vi4 is higher than the discharge start voltage with respect to sustain electrode SU1 through sustain electrode SUn.

Thus, feeble initializing discharge occurs again between scan electrode SC1 through scan electrode SCn and sustain electrode SU1 through sustain electrode SUn, and feeble initializing discharge occurs again between scan electrode SC1 through scan electrode SCn and data electrode D1 through data electrode Dm. The negative wall voltage on scan electrode SC1 through scan electrode SCn and the positive wall voltage on sustain electrode SU1 through sustain electrode SUn are reduced, and positive wall voltage on data electrode D1 through data electrode Dm is adjusted to wall voltage appropriate for an address operation by discharge of the excessive part. Thus, the forced initializing operation of causing initializing discharge in all discharge cells is completed.

In the subsequent address period, voltage 0 (V) is applied to data electrode D1 through data electrode Dm, voltage Ve is applied to sustain electrode SU1 through sustain electrode SUn, and voltage Vc is applied to scan electrode SC1 through scan electrode SCn.

Next, a scan pulse of negative voltage Va is applied to scan electrode SC1 of the first row, and an address pulse of positive voltage Vd is applied to data electrode Dk corresponding to the discharge cell to emit light in the first row, of data electrode D1 through data electrode Dm. At this time, the voltage difference in the intersecting part of data electrode Dk and scan electrode SC1 of the discharge cell to which an address pulse has been applied is derived by adding positive wall voltage on data electrode Dk to difference (Vd−Va) of the external applied voltage, and exceeds the discharge start voltage. Discharge thus occurs between data electrode Dk and scan electrode SC1, and the discharge develops to discharge between scan electrode SC1 and sustain electrode SU1. Thus, address discharge occurs. Then, positive wall voltage is accumulated on scan electrode SC1, negative wall voltage is accumulated on sustain electrode SU1, and negative wall voltage is also accumulated on data electrode Dk. Thus, the address operation of causing the address discharge in the discharge cell to emit light in the first row and accumulating wall voltage on each electrode is performed. While, the voltage in the part where data electrode 32 to which no address pulse has been applied intersects with scan electrode SC1 does not exceed the discharge start voltage, so that the address discharge does not occur.

Next, a scan pulse is applied to scan electrode SC2 of the second row, and an address pulse is applied to data electrode Dk corresponding to the discharge cell to emit light in the second row, of data electrode D1 through data electrode Dm. At this time, address discharge occurs between data electrode Dk and scan electrode SC2 and between sustain electrode SU2 and scan electrode SC2. Thus, positive wall voltage is accumulated on scan electrode SC2, negative wall voltage is accumulated on sustain electrode SU2, and negative wall voltage is also accumulated on data electrode Dk. Thus, an address operation of causing address discharge in the discharge cell to emit light in the second row and accumulating wall voltage on each electrode is performed. The voltage in the part where scan electrode SC2 intersects with data electrode 32 to which no address pulse has been applied does not exceed the discharge start voltage, so that address discharge does not occur.

A similar address operation is performed in the range of scan electrode SC3 of the third row through scan electrode SCn of the n-th row, thereby producing the wall charge required for subsequent sustain discharge in the discharge cell.

In the subsequent sustain period, voltage 0 (V) is applied to sustain electrode SU1 through sustain electrode SUn, and a sustain pulse of voltage Vs is applied to scan electrode SC1 through scan electrode SCn. In the discharge cell having undergone the address discharge, the voltage difference between scan electrode SCi and sustain electrode SUi is derived by adding the difference between the wall voltage on scan electrode SCi and that on sustain electrode SUi to voltage Vs, and exceeds the discharge start voltage between scan electrode SCi and sustain electrode SUi. Thus, sustain discharge occurs between scan electrode SCi and sustain electrode SUi, and ultraviolet rays generated at this time cause phosphor layer 35 to emit light. Negative wall voltage is accumulated on scan electrode SCi, and positive wall voltage is accumulated on sustain electrode SUi. Positive wall voltage is also accumulated on data electrode Dk. In the discharge cell having undergone no address discharge, sustain discharge does not occur and the wall voltage at the end of the initializing period is kept.

Subsequently, voltage 0 (V) is applied to scan electrode SC1 through scan electrode SCn, and a sustain pulse of voltage Vs is applied to sustain electrode SU1 through sustain electrode SUn. In the discharge cell having undergone the sustain discharge, sustain discharge occurs again and phosphor layer 35 emits light. Therefore, negative wall voltage is accumulated on sustain electrode SUi, and positive wall voltage is accumulated on scan electrode SCi.

Hereinafter, similarly, as many sustain pulses as the number corresponding to the luminance weight are alternately applied to scan electrode SC1 through scan electrode SCn and sustain electrode SU1 through sustain electrode SUn to continuously cause sustain discharge in the discharge cell having undergone the address discharge.

In the initializing period of the subsequent subfield SF2, voltage 0 (V) as a first voltage is applied to sustain electrode SU1 through sustain electrode SUn, and up-ramp waveform voltage, which gently increases to voltage Vr, is applied to scan electrode SC1 through scan electrode SCn. Thus, in the discharge cell having undergone sustain discharge in the sustain period of the immediately preceding subfield (subfield SF1, here) (the discharge cell having undergone address discharge in the address period in the subfield having no sustain period), the first discharge occurs where sustain electrode SUi is used as a negative electrode and scan electrode SCi is used as a positive electrode. This first discharge is feeble. The wall voltage on scan electrode SCi and sustain electrode SUi is reduced. In the present embodiment, voltage Vr is set to be equal to the value of voltage Vs, but voltage Vr may be set to be different from the value of voltage Vs.

Next, in a state where voltage 0 (V) is applied to sustain electrode SU1 through sustain electrode SUn, down-ramp waveform voltage, which gently decreases from voltage 0 (V) to voltage Vi4, is applied to scan electrode SC1 through scan electrode SCn. At this time, in the discharge cell having undergone the feeble first discharge, feeble discharge occurs again. The feeble discharge at this time is second discharge where scan electrode SCi is used as a negative electrode and data electrode Dk is used as a positive electrode. In the present embodiment, voltage Vi4 is set to be equal to or slightly higher than the value of voltage Va of the scan pulse.

Then, a positive rectangular waveform voltage (rectangular waveform voltage of voltage Vr, in the present embodiment) is applied to scan electrode SC1 through scan electrode SCn for time Te. Time Te is the length of the applying time of the positive rectangular waveform voltage applied to scan electrode SC1 through scan electrode SCn in the selective initializing operation.

Thus, third discharge occurs in the discharge cell having undergone the feeble second discharge. The discharge at this time is third discharge where sustain electrode SUi is used as a negative electrode and scan electrode SCi is used as a positive electrode, and is feeble.

Then, voltage Ve as the second voltage higher than the first voltage (0 (V)) is applied to sustain electrode SU1 through sustain electrode SUn, and down-ramp waveform voltage, which gently decreases from voltage 0 (V) to voltage Vi4, is applied to scan electrode SC1 through scan electrode SCn. At this time, fourth discharge occurs in the discharge cell having undergone the third discharge. The discharge at this time is fourth discharge where scan electrode SCi is used as a negative electrode and data electrode Dk is used as a positive electrode. Excessive parts of the wall voltage on scan electrode SCi, the wall voltage on sustain electrode SUi, and the wall voltage on data electrode Dk are discharged, and these wall voltages are adjusted to wall voltages appropriate for the address operation. Thus, the initializing operation in subfield SF2 is completed. This initializing operation is a selective initializing operation of selectively performing initializing discharge in the discharge cell that has undergone a sustain operation in the sustain period of the immediately preceding subfield. In a subfield having no sustain period, this discharge cell is the discharge cell that has undergone an address operation in the address period.

The operation of the address period of subsequent subfield SF2 is similar to that of the address period of subfield SF1. The operation of the sustain period of subfield SF2 is similar to that of the sustain period of subfield SF1 except for the number of sustain pulses. Each operation of subfield SF3 through subfield SF10 is similar to the operation of subfield SF2 except for the number of sustain pulses.

In the present embodiment, voltage Vi1 is 200 (V), voltage Vi2 is 400 (V), voltage Vi3 is 200 (V), voltage Vi4 is −180 (V), voltage Vc is 20 (V), voltage Va is −200 (V), voltage Vs is 200 (V), voltage Vr is 200 (V), voltage Ve is 150 (V), and voltage Vd is 60 (V). The gradient of the up-ramp waveform voltage is set between 1 and 10 (V/μsec), and the gradient of the down-ramp waveform voltage is set between −1 and −10 (V/μsec). In the present invention, however, these voltage values are not limited to the above-mentioned values, and preferably are set optimally based on the characteristics of the panel and the specification or the like of the plasma display apparatus.

In the present embodiment, time Te is an adjusted value set for each subfield, and is set between 1 and 500 μsec. Details on time Te are described later.

As discussed above, in the initializing period where the selective initializing operation is performed in the present embodiment, the first discharge where sustain electrode SUi is used as a negative electrode and scan electrode SCi is used as a positive electrode is caused. Next, the second discharge where scan electrode SCi is used as a negative electrode and data electrode Dk is used as a positive electrode is caused. Next, the third discharge where sustain electrode SUi is used as a negative electrode and scan electrode SCi is used as a positive electrode is caused. Next, the fourth discharge where scan electrode SCi is used as a negative electrode and data electrode Dk is used as a positive electrode is caused. In order to cause these discharges as weak discharges and suppress the luminance of light emission caused by these discharges, the following processes are performed:
applying the first voltage to sustain electrode SU1 through sustain electrode SUn and applying an up-ramp waveform voltage to scan electrode SC1 through scan electrode SCn;
next, applying a down-ramp waveform voltage to scan electrode SC1 through scan electrode SCn;
next, applying a positive rectangular waveform voltage to scan electrode SC1 through scan electrode SCn;
next, applying the second voltage higher than the first voltage to sustain electrode SU1 through sustain electrode SUn and applying down-ramp waveform voltage to scan electrode SC1 through scan electrode SCn.

Thus, by repeatedly causing feeble discharge a plurality of times without causing strong discharge, sufficient wall voltage can be accumulated on each electrode and the subsequent address discharge can be stably caused.

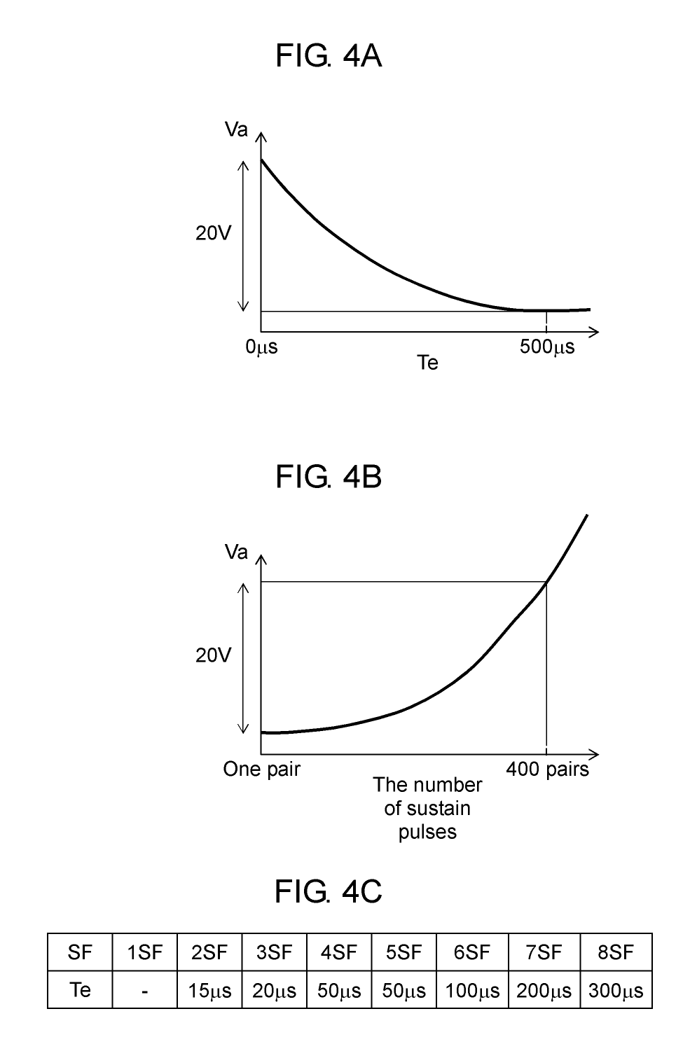

FIG. 4A is a diagram showing the relationship between the length of the applying period of the rectangular waveform voltage to scan electrode SC1 through scan electrode SCn in the selective initializing period and voltage Va required for causing the stable address discharge in accordance with the exemplary embodiment of the present invention. FIG. 4A, the vertical axis shows voltage Va (amplitude of scan pulses) for causing the stable address discharge. The horizontal axis shows time Te as the length of the applying period of the rectangular waveform voltage to scan electrode SC1 through scan electrode SCn in the selective initializing period.

FIG. 4B is a diagram showing the relationship between the number of sustain pulses occurring in the sustain period and voltage Va required for causing stable address discharge. In FIG. 4B, the vertical axis shows voltage Va (amplitude of scan pulses) for causing the stable address discharge. The horizontal axis shows the number of sustain pulses occurring in the sustain period of the immediately preceding subfield. “One pair” shown in FIG. 4B means that a sustain pulse is applied to scan electrode 22 once and a sustain pulse is applied to sustain electrode 23 once.

FIG. 4C is a diagram showing one example of time Te set for each subfield in accordance with the exemplary embodiment of the present invention. FIG. 4C shows a setting example of time Te when one field is formed of 8 subfields (SF1, SF2, . . . , SF8), and luminance weights of (1, 2, 4, 8, 16, 32, 64, 128) are set for respective subfields. Time Te is the length of the applying time of the rectangular waveform voltage of voltage Vr to scan electrode SC1 through scan electrode SCn in the selective initializing period.

In the drawings, “μsec” is briefly expressed by “μs”.

The inventor has recognized that voltage Va (amplitude of scan pulses) required for causing the stable address discharge can be decreased as time Te is increased, as shown in FIG. 4A. In the example shown in FIG. 4A, the amplitude of scan pulses required for causing the stable address discharge can be made smaller by about 20 (V) when time Te is set at 500 μsec than when time Te is set at 0 μsec (namely, the rectangular waveform voltage is not applied to scan electrode SC1 through scan electrode SCn).

The inventor has recognized that voltage Va (amplitude of scan pulses) required for causing the stable address discharge increases as the number of sustain pulses occurring in the sustain period of the immediately preceding subfield increases, as shown in FIG. 4B. In the example shown in FIG. 4B, the amplitude of scan pulses required for causing the stable address discharge is larger by about 20 (V) in the address period of the subfield having undergone 400 pairs of sustain pulses in the sustain period of the immediately preceding subfield than in the address period of the subfield having undergone one pair of sustain pulses in the sustain period of the immediately preceding subfield.

Thus, in order to reduce voltage Va (amplitude of scan pulses) required for causing the stable address discharge, time Te is not required to be long in all subfields, but is set in response to the number of sustain pulses occurring in the sustain period of the immediately preceding subfield. In other words, when the number of sustain pulses occurring in the sustain period of the immediately preceding subfield decreases, voltage Va (amplitude of scan pulses) required for causing the stable address discharge decreases, and hence time Te can be set at a relatively short time. When the number of sustain pulses occurring in the sustain period of the immediately preceding subfield increases, voltage Va (amplitude of scan pulses) required for causing the stable address discharge increases, and hence time Te is preferably set at a relatively long time.

In the present embodiment, time Te is set in response to the number of sustain pulses occurring in the sustain period of the immediately preceding subfield. In other words, time Te is set at a relatively short time when the number of sustain pulses occurring in the sustain period of the immediately preceding subfield is relatively small, and time Te is set at a relatively long time when the number of sustain pulses occurring in the sustain period of the immediately preceding subfield is relatively large.

For example, when one field is formed of 8 subfields (SF1, SF2, . . . , SF8), and luminance weights of (1, 2, 4, 8, 16, 32, 64, 128) are set for respective subfields, the number of sustain pulses occurring in subfield SF1 is smallest in one field because the luminance weight is “1” in the subfield (subfield SF1) immediately preceding subfield SF2. Therefore, time Te can be set to be smallest in subfield SF2. In the example shown in FIG. 4C, time Te of subfield SF2 is 15 μsec.

In the subfield (subfield SF7) immediately before subfield SF8, the luminance weight is “64”, and the number of occurring sustain pulses is the second largest number in one field. Therefore, preferably, time Te is set to be the largest in subfield SF8. In the example of FIG. 4C, time Te of subfield SF8 is 300 μsec.

In the above-mentioned subfield structure, the number of sustain pulses occurring in subfield SF8 is the largest in one field. However, the subfield following subfield SF8 is subfield SF1 in the next field, and rectangular waveform voltage is not generated because a forced initializing operation is performed in subfield SF1. Therefore, in the example of FIG. 4C, the set value of time Te of subfield SF8 is the largest in one field.

In the example of FIG. 4C, in response to the number of sustain pulses occurring in the sustain period of the immediately preceding subfield, time Te is set at 20 μsec in subfield SF3, 50 μsec in subfield SF4, 50 μsec in subfield SF5, 100 μsec in subfield SF6, and 200 μsec in subfield SF7.

In the example of FIG. 4C, time Te is set at 50 μsec both in subfield SF4 and subfield SF5, though the number of sustain pulses occurring in the sustain period of the immediately preceding subfield differs between subfield SF4 and subfield SF5. Thus, even when the number of sustain pulses occurring in the sustain period of the immediately preceding subfield differs, time Te may be set at the same time length in consideration of the discharge characteristics of the panel and the specification of the plasma display apparatus, for example, when the time required for driving is insufficient.

Thus, in the present embodiment, time Te is set in response to the number of sustain pulses occurring in the sustain period of the immediately preceding subfield. In other words, time Te is set at a relatively short time when the number of sustain pulses occurring in the sustain period of the immediately preceding subfield is relatively small, and time Te is set at a relatively long time when the number of sustain pulses occurring in the sustain period of the immediately preceding subfield is relatively large. Voltage Va (amplitude of scan pulses) required for causing the stable address discharge can be therefore decreased. This setting can achieve a plasma display apparatus that causes stable address discharge while securing a sufficient voltage setting margin and displays an image of high display quality.

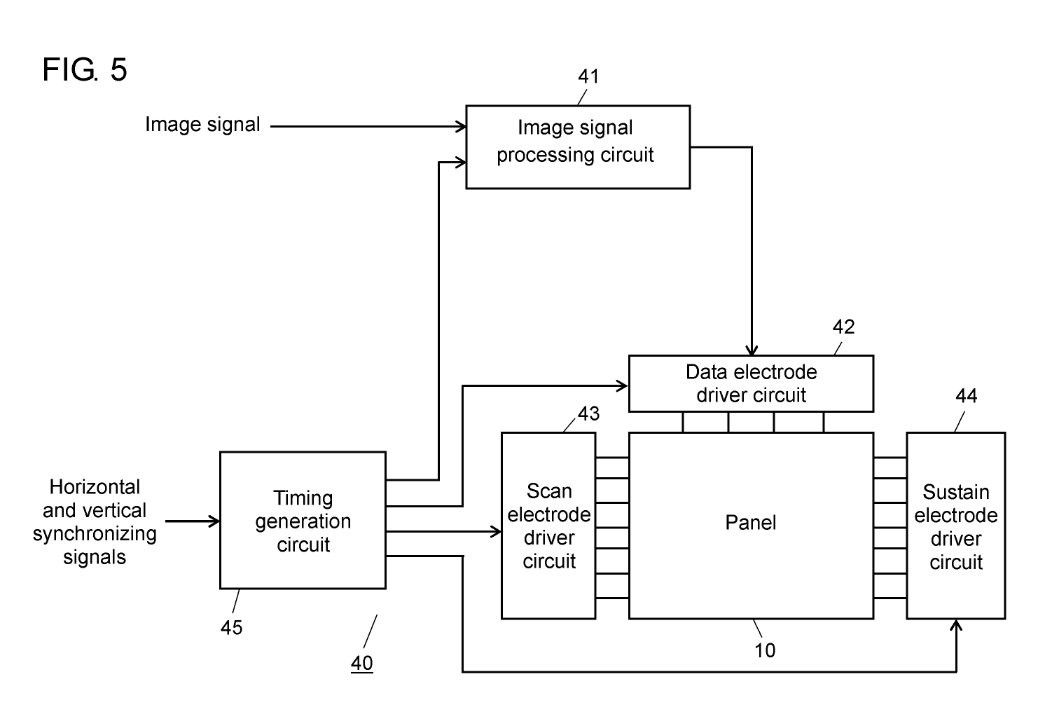

Next, a driver circuit for driving panel 10 is described. FIG. 5 is a circuit block diagram of plasma display apparatus 40 in accordance with the exemplary embodiment of the present invention. Plasma display apparatus 40 has panel 10 having a plurality of discharge cells having scan electrode 22, sustain electrode 23, and data electrode 32, and a driver circuit for driving panel 10. The driver circuit includes the following elements:
image signal processing circuit 41;
data electrode driver circuit 42;
scan electrode driver circuit 43;
sustain electrode driver circuit 44;
timing generation circuit 45; and
a power supply circuit (not shown) for supplying required power to each circuit block.

Image signal processing circuit 41 assigns a gradation value to each discharge cell based on an input image signal, and converts each gradation value into image data that indicates light emission or no light emission in each subfield.

Timing generation circuit 45 generates various timing signals for controlling operations of respective circuit blocks based on a horizontal synchronizing signal and a vertical synchronizing signal, and supplies the generated timing signals to respective circuit blocks.

Data electrode driver circuit 42 converts the image data in each subfield into an address pulse corresponding to each of data electrode D1 through data electrode Dm, and applies the address pulse to each of data electrode D1 through data electrode Dm based on the timing signals supplied from timing generation circuit 45.

Scan electrode driver circuit 43 has a sustain pulse generation circuit, a ramp waveform voltage generation circuit, and a scan pulse generation circuit (not shown). The ramp waveform voltage generation circuit generates up-ramp waveform voltage and down-ramp waveform voltage to be applied to scan electrode SC1 through scan electrode SCn in the initializing period. The sustain pulse generation circuit generates sustain pulses to be applied to scan electrode SC1 through scan electrode SCn in the sustain period. The scan pulse generation circuit has a plurality of scan electrode driver integrated circuits (scan ICs), and generates scan pulses to be applied to scan electrode SC1 through scan electrode SCn in the address period. Scan electrode driver circuit 43 generates the above-mentioned driving voltage waveforms based on the timing signals supplied from timing generation circuit 45, and appropriately applies them to scan electrode SC1 through scan electrode SCn.

Sustain electrode driver circuit 44 has a sustain pulse generation circuit (not shown). Sustain electrode driver circuit 44 generates the above-mentioned driving voltage waveforms based on the timing signals supplied from timing generation circuit 45, and appropriately applies them to sustain electrode SU1 through sustain electrode SUn.

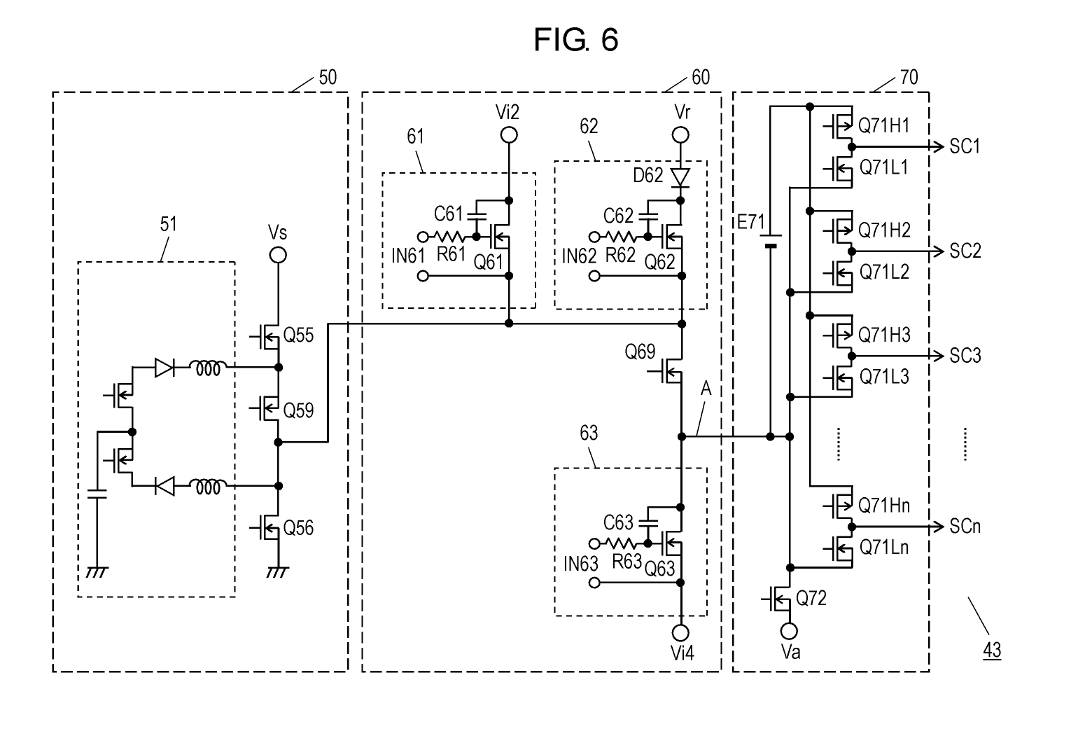

FIG. 6 is a circuit diagram of scan electrode driver circuit 43 of plasma display apparatus 40 in accordance with the exemplary embodiment of the present invention. Scan electrode driver circuit 43 has sustain pulse generation circuit 50, ramp waveform voltage generation circuit 60, and scan pulse generation circuit 70.

Sustain pulse generation circuit 50 has power recovery circuit 51, switching element Q55, switching element Q56, and switching element Q59. Sustain pulse generation circuit 50 generates sustain pulses to be applied to scan electrode SC1 through scan electrode SCn. Power recovery circuit 51 recovers electric power, which is accumulated in panel 10, from panel 10 using LC (inductance-capacitance) resonance, reuses the recovered electric power as electric power in driving scan electrode SC1 through scan electrode SCn, and supplies it to panel 10 again. Switching element Q55 clamps scan electrode SC1 through scan electrode SCn on voltage Vs, and switching element Q56 clamps scan electrode SC1 through scan electrode SCn on voltage 0 (V). Switching element Q59 is a separation switch, and prevents current from flowing back via a parasitic diode or the like of the switching element that is included in scan electrode driver circuit 43.

Scan pulse generation circuit 70 has switching element Q71H1 through switching element Q71Hn, switching element Q71L1 through switching element Q71Ln, switching element Q72, a power supply of negative voltage Va, and power supply E71 for generating voltage VC. Scan pulse generation circuit 70 superimposes voltage VC on the reference potential (potential at node A shown in FIG. 6) of scan pulse generation circuit 70 to generate voltage (V_{c}=VC+Va), and generates scan pulses by applying scan electrode SC1 through scan electrode SCn while switching between voltage Va and voltage Vc. For example, when voltage Va is −200 (V) and voltage VC is 220 (V), voltage Vc becomes 20 (V). Scan pulse generation circuit 70 sequentially applies scan pulses to scan electrode SC1 through scan electrode SCn with the timings shown in FIG. 3. Scan pulse generation circuit 70 outputs the output voltage of sustain pulse generation circuit 50 as it is in the sustain period. In other words, scan pulse generation circuit 70 outputs the voltage at node A to scan electrode SC1 through scan electrode SCn.

Ramp waveform voltage generation circuit 60 has Miller integrating circuit 61, Miller integrating circuit 62, and Miller integrating circuit 63, and generates the ramp waveform voltage shown in FIG. 3. Miller integrating circuit 61 has transistor Q61, capacitor C61, and resistor R61, and applies a fixed voltage to input terminal IN61 (makes a fixed voltage difference between two circles shown as input terminal IN61) to generate up-ramp waveform voltage that gently increases to voltage Vi2. Miller integrating circuit 62 has transistor Q62, capacitor C62, resistor R62, and diode D62 for preventing back flow, and applies a fixed voltage to input terminal IN62 (makes a fixed voltage difference between two circles shown as input terminal IN62) to generate up-ramp waveform voltage that gently increases to voltage Vr. Miller integrating circuit 63 has transistor Q63, capacitor C63, and resistor R63, and applies a fixed voltage to input terminal IN63 (makes a fixed voltage difference between two circles shown as input terminal IN63) to generate down-ramp waveform voltage that gently decreases to voltage Vi4. Switching element Q69 is a separation switch, and prevents current from flowing back via a parasitic diode or the like of the switching element that is included in scan electrode driver circuit 43.

These switching elements and transistors can be formed of generally known semiconductor elements such as a metal oxide semiconductor field effect transistor (MOSFET) or an insulated gate bipolar transistor (IGBT). These switching elements and transistors are controlled with timing signals that are generated in timing generation circuit 45 and correspond to the switching elements and transistors.

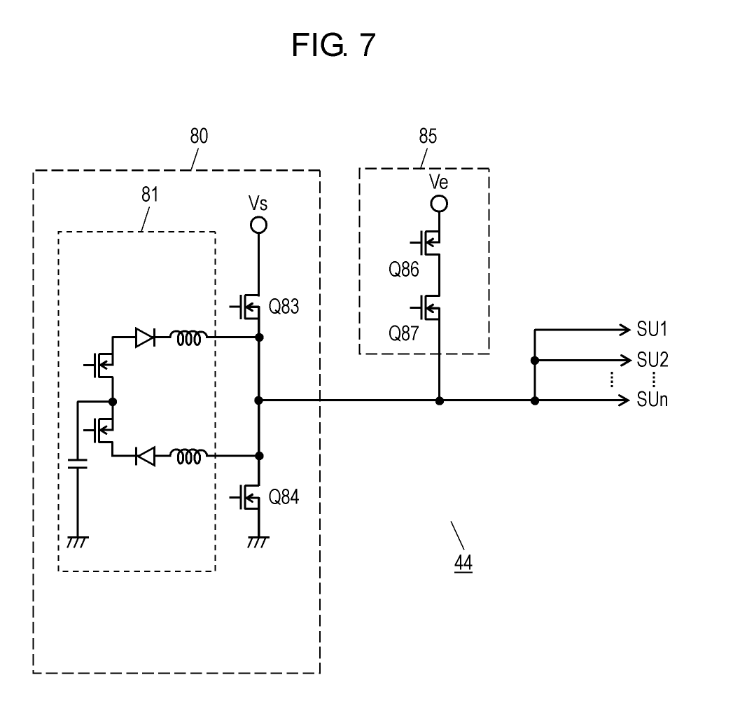

FIG. 7 is a circuit diagram of sustain electrode driver circuit 44 of plasma display apparatus 40 in accordance with the exemplary embodiment of the present invention. Sustain electrode driver circuit 44 has sustain pulse generation circuit 80 and fixed voltage generation circuit 85.

Sustain pulse generation circuit 80 has power recovery circuit 81, switching element Q83, and switching element Q84, and generates sustain pulses to be applied to sustain electrode SU1 through sustain electrode SUn. Power recovery circuit 81 recovers electric power, which is accumulated in panel 10, from panel 10 using LC resonance, reuses the recovered electric power as electric power in driving sustain electrode SU1 through sustain electrode SUn, and supplies it to panel 10 again. Switching element Q83 clamps sustain electrode SU1 through sustain electrode SUn on voltage Vs, and switching element Q84 clamps sustain electrode SU1 through sustain electrode SUn on voltage 0 (V).

Fixed voltage generation circuit 85 has switching element Q86 and switching element Q87, and applies voltage Ve to sustain electrode SU1 through sustain electrode SUn.

These switching elements can be also formed of generally known elements such as a MOSFET or an IGBT. These switching elements are controlled with timing signals that are generated in timing generation circuit 45 and correspond to the switching elements.

Next, a method of generating a driving voltage waveform that is applied to scan electrode SC1 through scan electrode SCn and sustain electrode SU1 through sustain electrode SUn in the initializing period of a subfield (for example, subfield SF2) undergoing the selective initializing operation is described. In this description, scan electrode driver circuit 43 of FIG. 6 and sustain electrode driver circuit 44 of FIG. 7 are used. Voltage Vr is assumed to be set at the same value as voltage Vs.

When voltage 0 (V) is applied to sustain electrode SU1 through sustain electrode SUn, switching element Q84 of sustain electrode driver circuit 44 is conducted (hereinafter referred to as “is set at ON”).

When up-ramp waveform voltage, which gently increases to voltage Vr, is applied to scan electrode SC1 through scan electrode SCn, the following steps are performed:
switching element Q71L1 through switching element Q71Ln and switching element Q69 of scan electrode driver circuit 43 are set at ON; and
a fixed voltage is applied to input terminal IN62 (a fixed voltage difference is applied between two circles shown as input terminal IN62) to operate Miller integrating circuit 62.

When down-ramp waveform voltage, which gently decreases from voltage 0 (V) to voltage Vi4, is applied to scan electrode SC1 through scan electrode SCn, the following steps are performed:
voltage 0 (V) is applied to input terminal IN62 of Miller integrating circuit 62 (voltage difference between two circles shown as input terminal IN62 is set at 0 (V)) to cut off transistor Q62 (hereinafter referred to as “set at OFF”);
switching element Q56 is set at ON; and
voltage 0 (V) is applied to scan electrode SC1 through scan electrode SCn.
   Then, switching element Q56 and switching element Q69 are set at OFF, a fixed voltage is applied to input terminal IN63 (a fixed voltage difference is applied between two circles shown as input terminal IN63) to operate Miller integrating circuit 63.

When rectangular waveform voltage of voltage Vr is applied to scan electrode SC1 through scan electrode SCn, the following steps are performed:
voltage 0 (V) is applied to input terminal IN63 of Miller integrating circuit 63 (voltage difference between two circles shown as input terminal IN63 is set at 0 (V)) to set transistor Q63 at OFF; and
switching element Q69, switching element Q59, and switching element Q55 are set at ON.
   Thus, voltage Vs, namely voltage Vr, is applied to scan electrode SC1 through scan electrode SCn. This state is continued for time Te.

When voltage Ve is applied to sustain electrode SU1 through sustain electrode SUn, the following steps are performed:
switching element Q84 of sustain electrode driver circuit 44 is set at OFF; and
switching element Q86 and switching element Q87 are set at ON.
   Thus, voltage Ve is applied to sustain electrode SU1 through sustain electrode SUn.

When down-ramp waveform voltage, which gently decreases from voltage 0 (V) to voltage Vi4, is applied to scan electrode SC1 through scan electrode SCn, the following steps are performed:
voltage 0 (V) is applied to input terminal IN62 of Miller integrating circuit 62 (voltage difference between two circles shown as input terminal IN62 is set at 0 (V)) to set transistor Q62 at OFF″;
switching element Q56 is set at ON; and
voltage 0 (V) is applied to scan electrode SC1 through scan electrode SCn.
   Then, switching element Q56 and switching element Q69 are set at OFF, and a fixed voltage is applied to input terminal IN63 of Miller integrating circuit 63 (a fixed voltage difference is applied between two circles shown as input terminal IN63) to operate Miller integrating circuit 63.

Switching element Q86 and switching element Q87 of sustain electrode driver circuit 44 may be set at OFF immediately before the voltage of scan electrode SC1 through scan electrode SCn reaches voltage Vi4, thereby putting sustain electrode SU1 through sustain electrode SUn into a high impedance state. Such driving can further stably cause the subsequent address operation. FIG. 3 shows such a driving voltage waveform. Alternatively, voltage Ve may be continuously applied to sustain electrode SU1 through sustain electrode SUn without putting sustain electrode SU1 through sustain electrode SUn into a high impedance state.

The driver circuits shown in FIG. 5 through FIG. 7 are simply examples, and the present invention is not limited to the configurations of these driver circuits.

The specific numerical values shown in the exemplary embodiment of the present invention and are simply examples, and the present invention is not limited to these numerical values. Preferably, these numerical values are set optimally in response to the characteristics of the panel and the specification of the plasma display apparatus.

### INDUSTRIAL APPLICABILITY

The present invention can provide a driving method for a panel and a plasma display apparatus that can cause stable address discharge while securing a sufficient voltage setting margin and display an image of high display quality.

### REFERENCE MARKS IN THE DRAWINGS

10 panel
21 front substrate
22 scan electrode
23 sustain electrode
24 display electrode pair
25 dielectric layer
26 protective layer
31 rear substrate
32 data electrode
33 dielectric layer
34 barrier rib
35 phosphor layer
40 plasma display apparatus
41 image signal processing circuit
42 data electrode driver circuit
43 scan electrode driver circuit
44 sustain electrode driver circuit
45 timing generation circuit
50, 80 sustain pulse generation circuit
51, 81 power recovery circuit
60 ramp waveform voltage generation circuit
61, 62, 63 Miller integrating circuit
70 scan pulse generation circuit
85 fixed voltage generation circuit
Q55, Q56, Q59, Q69, Q71H1 through Q71Hn, Q71L1 through Q71Ln, Q72, Q83,
Q84, Q86, Q87 switching element
E71 power supply
Q61, Q62, Q63 transistor
C61, C62, C63 capacitor
R61, R62, R63 resistor
IN61, IN62, IN63 input terminal
D62 diode

1. A method for driving a plasma display panel that includes a plurality of discharge cells each of which is formed of a scan electrode, a sustain electrode, and a data electrode, wherein the plasma display panel is driven with a structure of one field formed of a plurality of subfields each of which includes an initializing period and an address period, and a sustain period, the method comprising the steps of:
performing one of a forced initializing operation and a selective initializing operation in the initializing period, wherein the forced initializing operation generates initializing discharge in the discharge cells regardless of an operation in an immediately preceding subfield, and the selective initializing operation selectively generates initializing discharge only in a discharge cell that has undergone address discharge in the address period of an immediately preceding subfield;
during the selective initializing operation, applying a first voltage to the sustain electrode and applying an up-ramp waveform voltage to the scan electrode for generating a first time discharge between the sustain electrode working as a negative electrode and the scan electrode working as a positive electrode, then applying a down-ramp waveform voltage to the scan electrode for generating a second time discharge between the scan electrode working as a negative electrode and the data electrode working as a positive electrode, then applying a positive rectangular waveform voltage to the scan electrode for generating a third time discharge between the sustain electrode working as a negative electrode and the scan electrode working as a positive electrode, and then applying a second voltage higher than the first voltage to the sustain electrode and applying a down-ramp waveform voltage to the scan electrode for generating a fourth time discharge between the scan electrode working as a negative electrode and the data electrode working as a positive electrode, and
changing a time length of applying the positive rectangular waveform voltage to the scan electrode based on number of sustain pulses occurring in the sustain period of an immediately preceding subfield.

2. The driving method for the plasma display panel of claim 1, wherein
the length of the applying time of the positive rectangular waveform voltage to the scan electrode is set to be longer when the number of sustain pulses occurring in the sustain period of the immediately preceding subfield is large than when the number of sustain pulses occurring in the sustain period of the immediately preceding subfield is small.

3. A plasma display apparatus comprising:
a plasma display panel having a plurality of discharge cells each of which has a scan electrode, a sustain electrode, and a data electrode; and
a driver circuit that forms one field using a plurality of subfields each of which has an initializing period, an address period, and a sustain period, and drives the plasma display panel,
wherein, in the initializing period in the subfields, the driver circuit performs one of a forced initializing operation and a selective initializing operation, the forced initializing operation generating initializing discharge in the discharge cells regardless of an operation in an immediately preceding subfield, the selective initializing operation selectively generating initializing discharge only in a discharge cell that has undergone address discharge in the address period of the immediately preceding subfield,
wherein, in the selective initializing operation, the driver circuit
generates first discharge where the sustain electrode is used as a negative electrode and the scan electrode is used as a positive electrode by applying first voltage to the sustain electrode and applying up-ramp waveform voltage to the scan electrode,
next, generates second discharge where the scan electrode is used as a negative electrode and the data electrode is used as a positive electrode by applying down-ramp waveform voltage to the scan electrode,
next, generates third discharge where the sustain electrode is used as a negative electrode and the scan electrode is used as a positive electrode by applying positive rectangular waveform voltage to the scan electrode, and
next, generates fourth discharge where the scan electrode is used as a negative electrode and the data electrode is used as a positive electrode by applying second voltage higher than the first voltage to the sustain electrodes and applying down-ramp waveform voltage to the scan electrode, and
wherein, a length of applying time of the positive rectangular waveform voltage to the scan electrode is changed based on number of sustain pulses occurring in the sustain period of the immediately preceding subfield.

4. The plasma display apparatus of claim 3, wherein
the driver circuit sets the length of the applying time of the positive rectangular waveform voltage to the scan electrode to be longer when the number of sustain pulses occurring in the sustain period of the immediately preceding subfield is large than when the number of sustain pulses occurring in the sustain period of the immediately preceding subfield is small.
